(19) United States
(12) Patent Application Publication
(10) Pub. No.: US 2004/0029979 A1
(43) Pub. Date: Feb. 12, 2004

(54) Corrosion inhibiting rinsing agent

(76) Inventors: William Hopkins, Swillington (GB); Christopher Nettleship, Swillington (GB)

Correspondence Address: LOWE HAUPTMAN GILMAN & BERNER, LLP, Suite 300/310, 1700 Diagonal Road, Alexandria, VA, 22314, US

(21) Appl. No.: 10/327,648

(22) Filed: Dec. 24, 2002

Related U.S. Application Data
(63) Continuation of application No. 09/995,646, filed on Nov. 29, 2001, now Pat. No. 6,555,506.
Application No. 09/995,646 is a division of application No. 09/792,761, filed on Feb. 23, 2001, now Pat. No. 6,467,492.

(30) Foreign Application Priority Data
Feb. 23, 2000 (GB) 0004299.4

(51) Int. Cl. C09K 3/00

(52) U.S. Cl. 516/9

(57) ABSTRACT

A biodegradable alkaline rinsing agent composition suitable for neutralising acid on interior walls, and preventing corrosion in pipelines. The composition is an emulsifiable oily mixture of at least one vegetable oil base oil, at least one corrosion inhibitor, at least one amine; and at least one emulsifier. Preferably, there are at least two vegetable oils, at least two basic organic amines, at least two emulsifiers and a lime scale dispersant.

### RELATION TO OTHER APPLICATIONS

This application is a continuation of, and priority under 35 USC 120 is claimed from, application Ser. No. 09/995,646 filed Nov. 29, 2001, now U.S. Pat. No. 6,______; which is, in turn, a division of application Ser. No. 09/792,761, filed Feb. 23, 2001, now U.S. Pat. No. 6,467,492. Priority is also claimed under 35 USC 119 from UK application Serial No. 0004299.4 filed Feb. 23, 2000.

### BACKGROUND OF THE INVENTION

This invention relates to compositions that are suited to use as corrosion inhibiting rinsing agents primarily, but not exclusively, for use with oil well exploration and development pipelines. The invention relates more specifically to use of these rinsing agents in connection with ‘coiled tubing’.

The coiled tubing is typically a flexible steel pipe several kilometres in length with an internal diameter in the region of 5 centimeters. It is supplied and used by subcontractors who provide such services, as ‘well conditioning’ and well inspection, to oil production and exploration companies. While carrying out these operations various solutions may be circulated through the coiled tubing, for example ‘scale dissolver’. The exact compositions of most of these solutions are closely guarded secrets, with each subcontractor having their own proprietary blends. It is, however known that most of these compositions are based on hydrochloric acid or other such corrosive compounds.

On completion of a contract, to prevent corrosion of pipes by any residual scale dissolvers etc, the pipes are rinsed. A typical procedure for rinsing and cleaning the coiled tubing is to purge with nitrogen, rinse with a caustic solution to neutralise any acidic residues in an attempt to minimise corrosion, then purge again with nitrogen. Most of the corrosion in the pipes occurs between treatments.

Prior to committing a coiled tube to further contracts, it is inspected and pressure tested. Although pipes are rinsed after a period of sustained use, almost invariably heavy internal corrosion caused by use of acid conditioning agents, and from bi-products of the rinsing process, means that before pressure testing there is a need to clean the tube by ‘acid pickling’ to remove the corroded surface. This continuous cycle of corrosion and cleaning results in the walls of the tubing becoming thinned. The thinned walls increase the likelihood of pin holes forming and therefore leaks in the tubing during use, resulting in expensive downtime for the sub-contractor.

Although the need to find a solution to the problem of internal corrosion of coiled tubing has been recognised by the sub-contract companies, so far they have made little progress. The addition of caustic solution to neutralise any residual acids has proved ineffective, and may actually cause the corrosion to accelerate by forming sodium or potassium chlorides in situ which are known to be highly corrosive to steel. Another avenue that has been explored is the application of dry film resin bonded coatings to the internal surface of the tubing, however this has proved to be expensive and difficult to apply, therefore limiting it's use.

### GENERAL STATEMENT OF THE INVENTION

The present invention relates to a method of preventing corrosion in pipelines that have been acid treated after conventional use; as well as to a rinsing composition for use in corrosion prevention. One aspect of this invention comprises the method of treating pipelines, which method comprises: draining the pipeline to be treated of all residual compounds, blowing through with nitrogen or some other substantially inert fluid (preferably gas), and rinsing the pipeline with a rinsing agent. In one aspect of this invention, the rising agent is corrosion inhibiting. The rinsing agent is so formulated that it cleans out and neutralises any acid residues on the inside walls of the pipeline, and leaves a corrosion inhibiting oily film adhered to the inside walls of the pipeline/tubing. Preferably, the pipeline is rinsed with the rinsing agent immediately after each time that it is used and acid treated.

Another aspect of this invention constitutes a pacifier corrosion inhibiting rinsing agent that comprises an emulsifiable oil and passifier materials. This rinsing agent is put up in an aqueous emulsion for treatment. Upon applying the aqueous emulsion to the interior walls of the pipeline, the oily portion of the emulsion plates out on the wall surfaces creating lasting protection against corrosion of these walls.

In a preferred embodiment of the present invention, the corrosion inhibiting oil phase of the rinsing agent is biodegradable and comprises a mixture of one or more vegetable oil derived base oils, one or more emulsifiers, and one or more corrosion inhibitors, each of which are biodegradable. The components of the oil phase of the rinsing agent of this invention are substantially water immiscible

Where the product is intended for use offshore, or in another environment that is environmentally fragile and poses potential environmental issues, it is particularly desirable for the corrosion inhibiting rinsing agent of this invention to be biodegradable so that it does not contaminate the ocean and its wildlife. This biodegradability is adapted to prevent or at least mitigate any serious harm to aquatic organisms in the event of spillage

After a section of coiled tubing is used in a conventional manner, such as oil well conditioning, substantially all residual conditioning solutions are drained from the pipeline and the pipeline is removed from the oil well assembly. The pipeline is then blown through with a substantially inert gas, such as with nitrogen, and then immediately rinsed with a corrosion inhibiting rinsing agent, such as the agent of the present invention. This agent has the effect of: neutralising any residual acidic materials that have adhered to the pipe walls, removing residual materials (perhaps acidic) that have adhered to the pipe walls, and preventing future attack on the walls by acidic agents that may later come into contact with the pipe walls.

The acidic wall adherents have been conventionally neutralised with basic materials such as caustic. According to this invention, the acid neutralising is accomplished by employing amines as the neutralising component of the rinsing composition of this invention. Caustic and other inorganic basic materials are water soluble. Therefore, they can be relatively easily removed from the interior pipe walls in time and with exposure to outdoor storage weather conditions. According to this invention, basic materials that are substantially water insoluble, such as preferably triethanolamine, are used because they are oily and are resistant to being removed by the action of the ambient atmosphere. Amines have been found to be very effective in removing acidic residues from the interior pipe walls as well as, in the oil phase composition of this invention, being quite able to cling tenaciously to the interior pipe walls.

Once this rinsing solution has been flushed through the pipeline the oily phase of the composition, due to its vegetable oil and methyl ester content, ‘plates out’ a protective film, that includes the basic amine compound(s), that adheres to the inner surface of the tube/pipeline. Thus, not only does the rinsing composition of this invention act to neutralise and remove acidic residues from the interior pipe walls, but it also leaves a coating on the interior walls that tends to stick to the walls for a substantial period of time and be substantially unaffected by the ambient environment, wherefore inhibiting future corrosion that may be caused by ambient elements intruding into the interior of the pipe and causing inorganic basic materials to be stripped from the pipe walls while it is between jobs and is exposed to the environment. In a preferred aspect of this invention, this effect is enhanced by the use a mixed anionic/non-ionic emulsifier system. Such an emulsifier system not only keeps the oily portion of the composition in an oil in water emulsion, but also causes the oil droplets emulsified in the water phase to become larger, more unstable and therefore more likely to ‘plate out’ on the pipes interior walls. If possible, it is desired to apply so much of the oil phase of the instant neutralising composition that the interior pipe walls are substantially completely covered by a thin oil film containing acid-neutralising-basic amine(s)

By way of contrast to the use of oily neutralising compositions comprising amine compound(s), the prior art used a simple caustic rinse on the interior walls of the tubing. The prior art did not use any other system to neutralise or prevent further corrosion. The prior art did not provide a rinsing solution that not only neutralised residual acid promoted corrosion, but adhered to the interior pipe walls so as to retard the possibility of future corrosion. The corrosion inhibiting rinsing agents of the invention can be used either by flushing them through the pipe as a dilute emulsion or by introducing and passing a “plug” of oily rinsing agent in neat form through the pipe.

The above and other features of the present invention are illustrated by the following examples of corrosion inhibiting rinsing agents in accordance with the present invention.

### EXAMPLE 1

### Composition 1

| | |
|---|---|
| Methyl tallate | 35.0% (a methyl ester base oil derived |
| | from a vegetable oil) |
| 7-10 P Blown Rape Seed Oil | 35.0% (a vegetable oil) |
| Polydiethanolamide | 10.0% (a corrosion inhibitor) |
| Triethanolamine | 10.0% (an amine neutralising agent) |
| Etocas 29 | 10.0% (Ethoxylated castor oil; an |
| | emulsifier) |

were mixed together to form Composition 1, a semi-translucent oily liquid.

Testing

A 5″×3″ (127 mm×76.2 mm) mild steel panel was immersed in an aqueous acid solution (16% HCl) for 5 minutes, removed and placed in an emulsion of Composition 1 in water (Composition 1 made up 10% of the emulsion) for minute and then taken out. The panel stayed clear with no sign of corrosion even after 24 hours exposure to ambient conditions. When allowed to dry, a very light oil film was left behind on the mild steel plate.

In a comparative test using a rinse solution of 0.5% KOH aqueous solution, rusting was observed within 1 minute of application of the caustic solution.

### EXAMPLE 2

### Composition 2

| | |
|---|---|
| Lubriol 929.65 | 58.0% (vegetable oil) |
| 7-10 P Blown Rape Seed Oil | 10.0% (vegetable oil) |
| Polydiethanolamide | 10.0% (Corrosion inhibitor) |
| Triethanolamine | 10.0% (an amine neutralising agent) |
| Rewopol CT | 2.0% (Polyether Carboxylic Acid, a lime |
| | scale dispersant) |
| De-ionised Water | 3.0% |
| Etocas 29 | 7.0% (Ethoxilated castor oil emulsifying |
| | agent) |

were mixed to form Composition 2.

Testing

Three ‘U’ shaped pipe sections were immersed in an aqueous acid etch solution (16% HCl). The pipe sections were taken out of the acid etch, the aqueous acid solution drained from the pipe interior, and then soaked in a liquid neutralisiling emulsion, comprising 10%. Composition 2 and the remainder water, for 5 minutes. The pipe sections were then exposed to air.

When the pipe was allowed to dry in air, no corrosion was seen after 2 hours. When the pipes remained wet (at the bottom of the ‘U’ section where the oily composition of this invention did not penetrate to a sufficient extent), a small amount of corrosion was observed.

### EXAMPLE 3

### Composition 3

| | |
|---|---|
| Fatty ester | 22.5% (Epoil HL—obtainable from |
| | Hornett Bros) |
| 7-10 P Blown Rape Seed Oil | 22.5% (a vegetable oil) |
| Sunflower Oil | 9.0% (a vegetable oil) |
| Polydiethanolamide | 10.0% (a corrosion inhibitor) |
| Triethanolamine | 20.0% (an amine neutralising agent) |
| Tall oil fatty acid | 2.0% (a mixture of 22% mixed oleic and |
| | linoleic acids plus a maximum of Rosin |
| | acids; an emulsifying agent) |
| Rewopol CT | 2.0% (Polyether Carboxylic Acid, a lime |
| | scale dispersant) |
| Demineralized water | 10.0% |
| Fatty alcohol polyglycol ester | 3.0% (Emulsogen M—obtainable |
| | from Hoechst; an emulsifying agent) |

The Emulsogen M was added to stabilise the emulsion containing the formulation of Composition 3. This composition was a clear liquid.

Composition 3 was assembled as follows:

The fatty acid ester was added to a clean tank having a paddle mixer. The mixer was started and the 7-10P blown rape seed oil, sunflower oil, polydiethanolamide, triethanolamine, tall oil fatty acid and rewopol CT were added to the tank and the whole composition mixed for 15 minutes. The demineralized water and the fatty alcohol polyglycol ester were then added to the tank and the resultant composition mixed for a further 60 minutes.

Samples of Composition 3 were put in a refrigerator at 5° C. and in an oven at 40° C. and were found to be stable after 48 hours.

Testing

Samples of Composition 3 were emulsified at mixing ratios of 10:1, 20:1, 30:1 and 40:1 in water and were tested according to the IP287 Corrosion Test Procedure (The Institute of Petroleum ‘standard methods for analysis and testing of petroleum and related products’). At mixing ratios of 10:1, 20:1, 30:1 the panels showed a definite pass of the test, but at 40:1 dilution only a borderline pass was achieved.

In a further test of Composition 3, a section of steel tubing, as used in the field, was immersed in a 16% hydrochloric acid aqueous solution for 4 hours (to simulate pumping of the acidic conditioning solution through the pipe). The pipe was then removed and immediately immersed in a 10% v/v (in tap water) emulsion comprising Composition 3 for one minute. The section of tube was then removed and left open to the atmosphere. For comparison a second section of the same tubing was immersed in tap water for one minute, as per the current practice in the field, and then removed and left open to the ambient atmosphere.

The results were as follows:

| Rinsing solution | Results |
|---|---|
| Tap water | Surface rusting observed after 5 minutes of exposure |
| | to ambient atmosphere; 100% surface corrosion |
| | after one hour |
| Water emulsion | Surface free from corrosion after 72 hours of |
| comprising 10% of | exposure to ambient atmosphere (test stopped) |
| Composition 3 | |

In a further field test, a sample of Composition 3 was submitted to a coiled tubing contractor for field evaluation. Employing the “plug” method, an emulsion containing 20% Composition 3 was passed through the tubing. The tubing was then sealed and stored for a period of two months. After this time, sections of the treated tubing were cut open and inspected. The interior surfaces were found to free from corrosion.

Biodegradability

All of the above formulations consist of a vegetable oil derived base fluid with additives for emulsification, corrosion inhibition and alkaline neutralisation in which all the components are at least 90% biodegradable.

For example, in Composition 3 the fatty ester, 7-10P blown rape seed oil and sunflower oil constitute the vegetable oil derived base fluid; the triethanolamine, tall oil fatty acid and fatty alcohol polyglycol ester constitute the emulsifying agent; polydiethanolamide constitutes a corrosion inhibitor; triethanolamine constitutes an alkaline neutralising component of the composition; and rewopol CT serves to prevent scum formation due to reaction of the tall oil fatty acid with calcium ions in the water.

To confirm the biodegradability of these formulations, a sample of Composition 3 was tested according to method OECD 306 (ready biodegradation test as required by the Harmonised Offshore Chemical Notification Format guidelines). The results showed substantial biodegradation after 28 days.

What is claimed is:

1. A biodegradable, liquid, anti-corrosion oil-in-water emulsion rinsing agent wherein said oil phase comprises a base oil comprising at least one vegetable oil, at least one emulsifier, at least one acid neutralising amine and at least one corrosion inhibitor.

2. A rinsing agent as claimed in claim 1 wherein said oil phase comprises a base oil that is a combination of at least one oily organic fatty ester and at least one vegetable oil that is different from said oily organic fatty acid ester; a lime scale dispersant; a neutralising amine comprising at least triethanol amine; and at least one corrosion inhibitor comprising polydiethanolamide,
wherein said rinsing agent emulsion is adapted to be applied into contact with a metal surface, and, upon such contact, is adapted to plate out an oily corrosion protection film, comprising said oil phase, onto said metal surface.

3. A rinsing agent as claimed in claim 2 that is adapted to be applied to an inside wall of a steel pipe, and wherein said rinsing agent is adapted to plate out onto said steel wall.

4. A rinsing agent as claimed in claim 1 further comprising a combination of a plurality of emulsifiers.

5. A rinsing agent as claimed in claim 1 wherein each of the components of said oil phase is at least about 90% biodegradable.

6. A rinsing agent as claimed in claim 1 wherein said lime scale dispersant comprises a polyether carboxylic acid.

7. A rinsing agent as claimed in claim 4 further comprising a mixed anionic/non-ionic emulsifier.

8. A rinsing agent as claimed in claim 1 wherein said oily organic fatty ester comprises a methyl ester of a long chain fatty acid.

9. A rinsing agent as claimed in claim 8 wherein said oily organic fatty ester comprises methyl tallate.

10. A rinsing agent as claimed in claim 1 comprising an oil phase comprising: methyl tallate; rape seed oil; polydiethanolamide; triethanol amine; and ethoxylated castor oil.

11. A rinsing agent as claimed in claim 10 comprising an oil phase further comprising a polyethercarboxylic acid lime dispersant.

12. A rinsing agent as claimed in claim 11 comprising an oil phase further comprising sunflower oil.
